(19) United States
(12) Patent Application Publication
(10) Pub. No.: US 2026/0229253 A1
(43) Pub. Date: Aug. 6, 2026

(54) MAGNETIC RECORDING MEDIA/DISKS AND METHODS AND APPARATUS FOR IDENTIFYING MAGNETIC RECORDING MEDIA/DISKS SUITABLE FOR DATA STORAGE DEVICES

(71) Applicant: Western Digital Technologies, Inc., San Jose, CA (US)

(72) Inventors: Shoji Suzuki, San Jose, CA (US); Manabu Hattori, San Jose, CA (US)

(21) Appl. No.: 19/042,284

(22) Filed: Jan. 31, 2025

(51) Int. Cl. G11B 5/73; G11B 5/84; G11B 13/08

(52) U.S. Cl. CPC G11B 5/73921; G11B 5/84; G11B 13/08

(57) ABSTRACT

Magnetic recording disks and methods and apparatus of identifying a magnetic recording disk suitable for a data storage device configured for magnetic recording are described. In an aspect, a magnetic recording disk includes a glass substrate having a data surface, and a magnetic recording layer on the data surface for magnetic recording, where the magnetic recording disk has a thickness less than 0.5 millimeter. In this aspect, the magnetic recording disk has a flatness value corresponding to a height difference between a highest point and a lowest point on the data surface, and the flatness value is greater than a first flatness threshold and the data surface comprises one of a concave shape, a convex shape, and a cylinder shape.

### FIELD

The present disclosure relates to magnetic recording media, and more specifically, to magnetic recording media/disks suitable for data storage devices configured for magnetic recording and to methods and apparatus for identifying magnetic recording media/disks suitable for data storage devices configured for magnetic recording.

### INTRODUCTION

Magnetic storage systems, such as a hard disk drive (HDD), are utilized in a wide variety of devices in both stationary and mobile computing environments. Examples of devices that incorporate magnetic storage systems include desktop computers, portable notebook computers, portable hard disk drives, digital versatile disc (DVD) players, high-definition television (HDTV) receivers, vehicle control systems, cellular or mobile telephones, television set top boxes, digital cameras, digital video cameras, video game consoles, and portable media players.

A typical disk drive includes magnetic storage/recording media in the form of one or more flat disks or platters. The disks are generally formed of two main substances, namely, a substrate material that gives it structure and rigidity, and a magnetic media coating that holds the magnetic impulses or moments that represent data in a recording layer within the coating. The typical disk drive also includes a read head and a write head, generally in the form of a magnetic transducer which can sense and/or change the magnetic fields stored on the recording layer of the disk. When magnetic storage media uses a non-conductive substrate (such as a glass substrate and/or glass ceramic substrate), a conductive pre-seed layer may be deposited on the non-conductive substrate so that a bias voltage can be applied during the deposition of some or all of the subsequent media films to form the magnetic storage media. In some aspects, during a processing stage of the substrate, a surface of the substrate may not be uniform and thus may not be completely flat, for example, with height variations and/or irregularities. These height variations and/or irregularities may be considered in selecting a magnetic storage medium suitable for a data storage device.

### SUMMARY

In an aspect, a magnetic recording disk is provided. The magnetic recording disk includes a glass substrate having a data surface, and a magnetic recording layer on the data surface for magnetic recording, where the magnetic recording disk has a thickness less than 0.5 millimeter. The magnetic recording disk has a flatness value corresponding to a height difference between a highest point and a lowest point on the data surface, and the flatness value is greater than a first flatness threshold and the data surface comprises one of a concave shape, a convex shape, and a cylinder shape.

In another aspect, a data storage is provided. The data storage includes a magnetic recording disk that includes a glass substrate having a data surface, and a magnetic recording layer on the data surface for magnetic recording, where the magnetic recording disk has a thickness less than 0.5 millimeter. The magnetic recording disk has a flatness value corresponding to a height difference between a highest point and a lowest point on the data surface, and the flatness value is greater than a first flatness threshold and the data surface comprises one of a concave shape, a convex shape, and a cylinder shape. The data storage further includes at least one magnetic head, a drive mechanism for positioning the at least one magnetic head over the magnetic recording disk, and a controller electrically coupled to the at least one magnetic head for controlling operation of the at least one magnetic head.

In another aspect, a method of identifying a magnetic recording disk suitable for a data storage device configured for magnetic recording is provided. The method includes estimating a shape of a data surface of the magnetic recording disk, where the shape of the data surface is estimated to be one of a concave shape, a convex shape, a cylinder shape, and a saddle shape, and where the magnetic recording disk comprises a glass substrate. The method also includes determining a flatness threshold for the magnetic recording disk based on the shape of the data surface, and calculating a flatness value of the magnetic recording disk based on a height difference between a highest point and a lowest point on the data surface of the magnetic recording disk. The method further includes comparing the flatness value and the flatness threshold; and determining to utilize the magnetic recording disk for the data storage device based on the comparison of the flatness value and the flatness threshold.

In another aspect, a data storage device configured for magnetic recording is provided. The magnetic storage device includes a plurality of magnetic recording disks, each comprising a magnetic recording layer for magnetic recording, where each of the plurality of magnetic recording disks has a thickness of less than 0.5 millimeter, where each of the plurality of magnetic recording disks includes a glass substrate and a data surface, wherein each of the plurality of magnetic recording disks has a flatness value corresponding to a height difference between a highest point and a lowest point on the data surface, and at least one magnetic head configured to read from, and write to, the plurality of magnetic recording disks. In an aspect, at least one of the plurality of magnetic recording disks has a flatness value greater than 15 micrometers with a data surface comprising one of a concave shape, a convex shape, and a cylinder shape, and at least one of the plurality of magnetic recording disks has a flatness value less than or equal to 15 micrometers with a data surface comprising one of the concave shape, the convex shape, the cylinder shape, and a saddle shape.

In another aspect, an apparatus for identifying a magnetic recording disk suitable for a data storage device configured for magnetic recording is provided. The apparatus includes means for estimating a shape of a data surface of the magnetic recording disk, where the shape of the data surface is estimated to be one of a concave shape, a convex shape, a cylinder shape, and a saddle shape, means for determining a flatness threshold for the magnetic recording disk based on the shape of the data surface, and where the magnetic recording disk comprises a glass substrate, means for calculating a flatness value of the magnetic recording disk based on a height difference between a highest point and a lowest point on the data surface of the magnetic recording disk, means for comparing the flatness value and the flatness threshold, and means for determining to utilize the magnetic recording disk for the data storage device based on the comparison of the flatness value and the flatness threshold.

### BRIEF DESCRIPTION OF THE DRAWINGS

FIG. 1A illustrates a top plan view of a data storage device including a disk shaped magnetic recording medium (magnetic recording disk) in accordance with some aspects.

FIG. 1B illustrates a profile view of a slider and the magnetic recording medium of FIG. 1A in accordance with some aspects.

FIG. 2 illustrates an example fabrication process of glass substrate disks from a glass sheet that are configured to be further processed to form magnetic recording disks in accordance with some aspects.

FIG. 3A illustrates an example magnetic recording disk for magnetic recording, according to some aspects.

FIG. 3B illustrates an example expanded view of a cross section of a portion near an OD edge of the magnetic recording disk of FIG. 3A.

FIG. 4 is an example top plan view of a disk and head assembly and a slider at different portions of a magnetic recording disk, according to some aspects.

FIG. 5 is an example plot illustrating flatness values after a deposition process for various substrate thicknesses over different deposition temperatures, according to some aspects.

FIG. 6A shows an example plot showing a fly height modulation over wavelength associated with waviness of a surface of a substrate in a tangential direction, according to some aspects.

FIG. 6B shows a wavelength and an amplitude of an example periodic curve, according to some aspects.

FIG. 6C shows an example diagram showing three different waviness curves of a data surface with slider heads in various positions, according to some aspects.

FIG. 7 shows an example diagram showing four types of shapes of a data surface of a magnetic recording disk, according to some aspects.

FIG. 8A shows a result of a surface analysis of a data surface of a magnetic recording disk with a convex shape, according to some aspects.

FIG. 8B shows a result of a surface analysis of a data surface of a magnetic recording disk with a saddle shape, according to some aspects.

FIG. 8C shows a result of a surface analysis of a data surface of a magnetic recording disk with a cylinder shape, according to some aspects.

FIG. 9 illustrates an exemplary diagram for an apparatus for identifying a magnetic recording disk suitable for a data storage device configured for magnetic recording, according to some aspects.

FIG. 10 illustrates a method for identifying a magnetic recording disk suitable for a data storage device configured for magnetic recording, according to some aspects.

### DETAILED DESCRIPTION

In the following description, specific details are given to provide a thorough understanding of the various aspects of the disclosure. However, it will be understood by one of ordinary skill in the art that the aspects may be practiced without these specific details. For example, circuits may be shown in block diagrams in order to avoid obscuring the aspects in unnecessary detail. In other instances, well-known circuits, structures and techniques may not be shown in detail in order not to obscure the aspects of the disclosure.

As discussed above, when a substrate is fabricated to form a magnetic recording medium/disk for a data storage, certain height variations and/or irregularities on the surface of the magnetic recording disk may cause problems. Although a bare substrate before processing has a flat surface and thus is generally acceptable, conditions of the fabrication process, such as a high deposition temperature during a deposition process, may change the characteristics of the substrate when the magnetic recording disk is formed. Herein, new methods of characterizing a magnetic recording disk suitable for use in magnetic recording systems are presented to determine a flatness threshold is based on a shape of a data surface of the magnetic recording disk and determine whether to utilize the magnetic recording disk for the magnetic recording device by comparing a flatness value of the magnetic recording disk and a flatness threshold, where the flatness value is based on a height difference between a highest point and a lowest point on the data surface of the magnetic recording disk. Herein, the term “data surface” refers to the surface of a layer of a magnetic recording disk that is configured to encode data, such as the surface of a magnetic recording layer (MRL) of the disk. In particular, the shape of the data surface may be estimated to be one of a concave shape, a convex shape, a cylinder shape, and a saddle shape. A lower flatness threshold is used for the saddle shape than the other shapes because the saddle shape may cause more fly height fluctuation. The new methods may be beneficial to check if the magnetic recording disk is acceptable especially when a thickness of the magnetic recording disk is less than 0.5 millimeters and a deposition temperature greater than 675 degrees Celsius is used to form the magnetic recording disk, as a thin substrate exposed to a high deposition temperature may substantially change in shape and thus may potentially form an unacceptable magnetic recording disk. For example, considering that a typical glass transition temperature (Tg) for a glass substrate is generally between 750 degrees Celsius and 810 degrees Celsius, a deposition temperature of greater than 675 degrees Celsius is high enough to be near or higher than this typical Tg and thus is likely to cause change in shape in the glass substrate used to form a magnetic recording disk. Additionally, the glass substrate is generally held by a certain amount of force during the sputtering process. The force used to hold the glass substrate may change the shape of the glass substrate if the force is high. For example, a higher force used to hold the glass substrate during the sputtering process causes a larger flatness degradation. The force to hold the glass substrate is generally kept low enough to maintain original flatness before the deposition but high enough to hold the disk in a fixed position during the sputtering process.

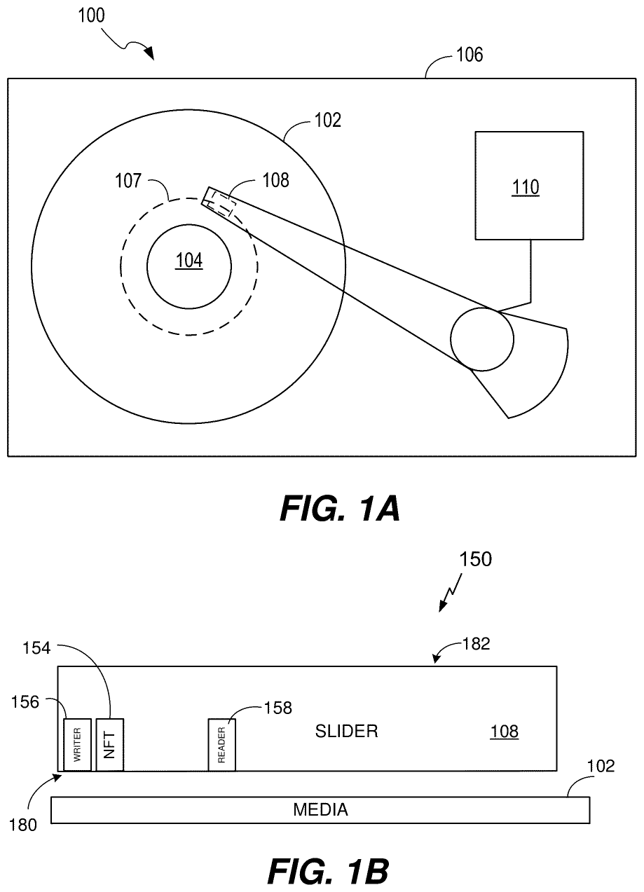

FIG. 1A is a top schematic view of a data storage device 100 configured for magnetic recording and including a disk shaped magnetic recording medium 102 in accordance with some aspects of the disclosure. In illustrative examples, the magnetic recording medium 102 is configured for perpendicular magnetic recording (PMR). However, other recording media, such as media configured for heat assisted magnetic recording (HAMR) or microwave assisted magnetic recording (MAMR) may be used in other examples. The data storage device 100 may include one or more disks/media 102 to store data. Disk/media 102 resides on a spindle assembly 104 that is mounted to drive housing 106. Data may be stored along tracks 107 along the magnetic recording layer of disk 102. The reading and writing of data are accomplished with the head/slider 108 that may have both read and write elements. The write element is used to alter the properties of the magnetic recording layer of disk 102 and thereby write information thereto. In one embodiment, recording head 108 may have magneto-resistive (MR), or giant magneto-resistive (GMR) elements, such as tunnel magneto-resistive (TMR) elements for reading, and a write pole with coils that can be energized for writing. In another embodiment, head 108 may be another type of head, for example, an inductive read/write head or a Hall effect head. In operation, a spindle motor (not shown) rotates the spindle assembly 104, and thereby rotates disk 102 to position head 108 at a particular location along a desired disk track 107. The position of the head 108 relative to the disk 102 may be controlled by position control circuitry 110.

FIG. 1B illustrates a profile view of the slider 108 and the magnetic recording medium 102 of FIG. 1A in accordance with some aspects of the disclosure. In particular, FIG. 1B illustrates an assembly 150 that includes the slider 108, a near-field transducer (NFT) 154 (if the head is configured for heat assisted magnetic recording (HAMR)), a writer 156 and a reader 158. It is noted that FIG. 1B is not drawn to scale and generally the slider 108 is substantially smaller than the media 102 (e.g., as shown in FIG. 1A). The NFT 154 may be omitted in a non-HAMR slider, and other components may be used instead in other types of energy assisted recording technology (e.g., a spin torque oscillator (STO) in a microwave assisted magnetic recording (MAMR) head). The assembly 150 may further include a laser (not shown) configured to direct light energy to the NFT 154 during a writing process, wherein the NFT may generate localized heat energy, in response to the light energy, to assist the writing process. The laser may be mounted to, or made integral to, the slider 108. If the slider 108 is not configured for HAMR (e.g., is configured for non-HAMR applications), the laser and NFT may be omitted. The assembly 150 is positioned over the media 102. The slider 108 may be one component or several components. The slider 108 may include a slider body and a slider head. In some implementations, a slider head may be a separate component that may be integrated with the slider 108. The NFT 154, the writer 156 and the reader 158 may be implemented in the slider, the slider head or combinations thereof.

The slider 108 includes a first surface 180 (e.g., bottom surface) that faces the media 102. The first surface 180 may be referred to as an air bearing surface (ABS). The slider 108 also includes a second surface 182 (e.g., top surface) that faces away from the media 102. The NFT 154, the writer 156 and the reader 158 may be located near or along the first surface 180 of the slider 108. The writer 156 may be a writing element (e.g., means for writing data) for writing data on the media 102, and the reader 158 may be a reading element (e.g., means for reading data) for reading data on the media 102. The writer 156 may include a write pole.

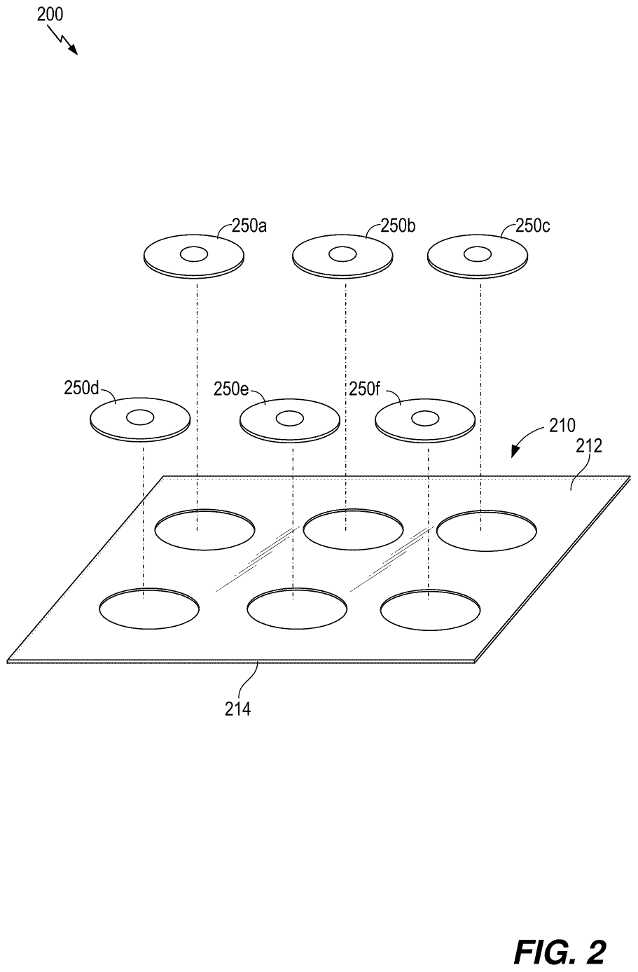

FIG. 2 illustrates an example fabrication process of glass substrate disks from a glass sheet that are configured to be further processed to form magnetic recording disks in accordance with some aspects. To manufacture a magnetic recording disk such as the disk 102 of FIG. 1A, a glass sheet may be cut into multiple glass substrate disks, and the glass substrate disks may be further processed to form magnetic recording disks (e.g., using one or more deposition processes wherein at least one magnetic recording layer is added). As shown in FIG. 2, for example, a glass sheet 210 with a first surface 212 and a second surface 214 are cut into glass substrate disks 230a, 230b, 230c, 230d, 230e, and 230f, which are then processed to form magnetic recording disks (e.g., after undergoing further cutting and various deposition steps). In some examples, the glass sheet may be divided into multiple regions from which multiple glass substrate disks for magnetic recording disks are cut. In the example illustrated in FIG. 2, the glass sheet 210 is divided into six regions, and the glass substrate disks 230a, 230b, 230c, 230d, 230e, and 230f are cut from the six regions, respectively. In other examples, the glass sheet may be divided into less than or greater than six regions depending on the size of the glass substrates desired and the size of the glass sheet.

A glass sheet is generally an unfinished sheet of glass that may have foreign substances, defects, and/or roughness. Glass substrate disks for the magnetic recording disks generally require a smooth surface with few or no defects. Therefore, after cutting the glass sheet into glass substrate disks, multiple polishing steps and/or a lapping process may be applied to each glass substrate disk to achieve the desired smoothness in the surface and/or to adjust a thickness of the glass substrate.

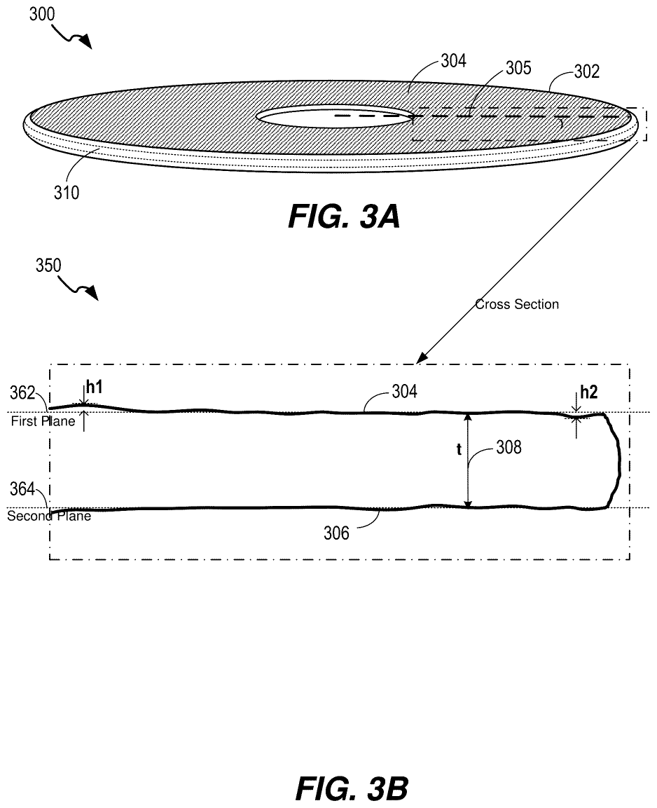

FIGS. 3A and 3B illustrate example diagrams showing a magnetic recording disk and a cross section of a portion of the magnetic recording disk, according to some aspects. FIG. 3A illustrates an exemplary diagram 300 showing a magnetic recording disk 302 for magnetic recording. FIG. 3B illustrates an example view 350 of a cross section of a portion of the magnetic recording disk 302. The cross section shown in FIG. 3 may be taken along a plane perpendicular to a first surface 304 and along a radial line 305 of the magnetic recording disk 302. The magnetic recording disk 302, which may be configured for magnetic recording, may have the first surface 304 extending along a first plane 362 and a second surface 306 extending along a second plane 364 parallel to the first plane 362. The first surface 304 may be a data surface where data may be magnetically recorded in a magnetic recording layer of the magnetic recording disk 302 (e.g., once it has been deposited). For example, the data may be recorded in the magnetic recording layer of the magnetic recording disk 302 using a recording head (e.g., recording head 108). A disk thickness (t) 308 is the thickness between the first surface 304 and the second surface 306, and may be measured along a direction substantially normal to the first plane 362 or the second plane 364. In some aspects, the disk thickness may be less than or equal to 0.5 mm. The magnetic recording disk 302 may further have an outer diameter (OD) edge along a perimeter edge of the magnetic recording disk 302. An OD region is a region at or around an OD edge and includes the outer end of the data surface of a magnetic recording disk.

As shown in FIG. 3B, the data surface of the magnetic recording disk 302 is generally not completely smooth but rather fluctuates in shape, which may be called waviness. Hence, heights on the data surface vary depending on a location on the data surface. A height for a particular point the data surface may be measured by measuring a perpendicular distance from the first plane 362 to the particular point on the data surface. For example, for portion of the data surface that corresponds to the cross section shown in FIG. 3B, the first height h1 shows the highest point on this portion of the data surface and the second height h2 shows the lowest point on this portion of the data surface.

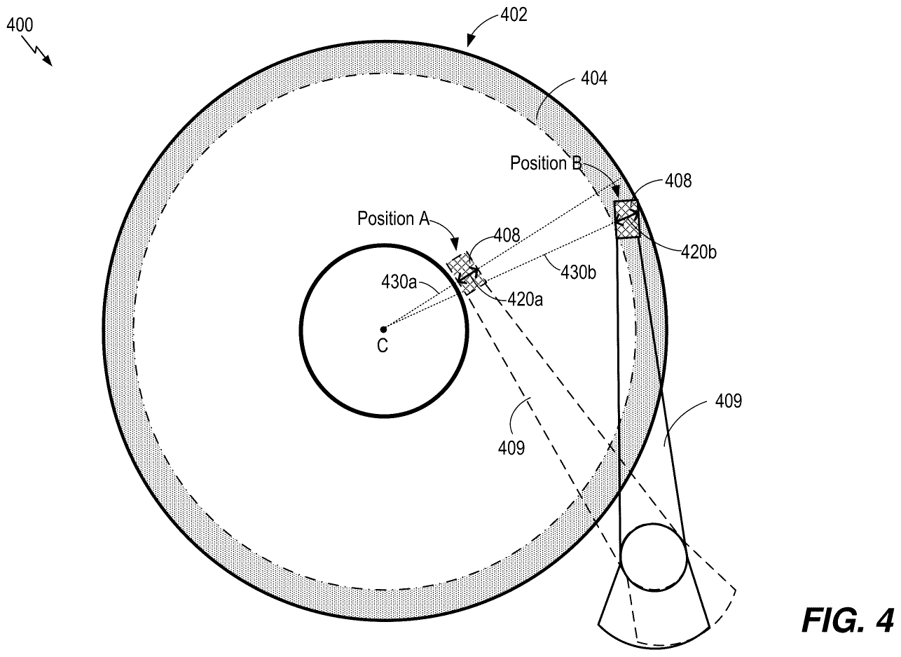

FIG. 4 illustrates a top plan view 400 of a disk and head assembly and a slider positioned at different portions of a magnetic recording disk, according to some aspects. FIG. 4 shows a top view of a magnetic recording disk 402 and a slider 408 positioned at the end of a suspension 409 and above the magnetic recording disk 402 at multiple positions. Here, the center (C) is the center of the circle defined by the circularly shaped magnetic recording disk 402. (Note that the disk ID center might not be perfectly aligned with the rotating spindle of the HDD because mass balance is controlled by shifting the positions of the disks in the radial direction.) As shown in FIG. 4, the magnetic recording disk 402 has an OD region 404 near an OD of the magnetic recording disk 402. The magnetic recording disk 402 also has an inner diameter (ID) region near an inner diameter of the magnetic recording disk. When the slider 408 is at Position A in the ID region, the slider 408 reads data from the data surface along an ID track 452. When the slider 408 is at Position B in the OD region, the slider 408 reads data from the data surface along an OD track 462. The reading of the data along a track on the data surface may be affected by irregularities or waviness of the data surface, which is discussed more in detail below.

As shown in FIG. 4, when the slider 408 is at Position A near an inner diameter (ID) of the magnetic recording disk 402, a measurement line 420a that is on a straight radial line 430a toward the center (C) of the magnetic recording disk 402 (e.g., a line or length across the slider body which is normal to the circular tracks extending along the disk, where this line/length will be parallel with a radial line of the magnetic recording disk) is parallel or substantially parallel to a width of the slider 408 and has the same or substantially the same linear length as the width of the slider 408. Here, the center (C) is the center of the circle defined by the circularly shaped magnetic recording disk 402. On the other hand, when the slider 408 is at the OD region 404 (e.g., near the OD), a measurement line 420b (e.g., that is on a straight radial line 430b toward the center (C) of the magnetic recording disk 402) is at an angle from a line in the width direction of the slider 408.

A degree of how flat a surface of a magnetic recording disk is may provide information on a condition of the magnetic recording disk. Hence, a flatness of a magnetic recording disk may be used as a measure to determine whether to accept the magnetic recording disk for a data storage device. A flatness value of a magnetic recording disk is defined as a difference between the highest point and lowest point on a data surface of the magnetic recording disk. Hence, a greater flatness value means that the substrate is less flat. Currently, for a 97 mm magnetic recording disk, an acceptable flatness value is 15 μm or less. This flatness requirement is based on an assumption that the disk flatness does not significantly change after substrate processing, such as deposition processes and a sputtering process.

A bare substrate before media processing is generally flat and thus is usually acceptable. For example, even for a thin substrate with a thickness of 0.38 mm, the flatness value before media processing is generally less than 15 μm, which is acceptable. However, a flatness of a substrate may change during a fabrication process for forming a magnetic recording disk, such as a deposition process and/or a sputtering process. For example, a flatness of a substrate may change during a deposition process to deposit one or more layers on the substrate, due to a high deposition temperature. In order to achieve a higher recording density, a deposition temperature higher than 650° C. may be used during the deposition process, which may change the flatness of a substrate when the magnetic recording disk is formed. For example, a deposition temperature of 700° C. may be used to produce magnetic layers for HAMR recordings. Further, in order to add more platters in a magnetic storage device with a thin chassis (e.g., 1 inch), a substrate with a reduced substrate thickness may be used, where, for example, the substrate thickness is less than 0.5 mm. Due to the high deposition temperature and the reduced substrate thickness, the flatness of the substrate is likely to change during the deposition process, and thus the flatness of the magnetic recording disk formed from the substrate may have a changed flatness after the deposition process. Therefore, it is beneficial to monitor the flatness of the substrate that may change during the deposition process, especially when a high deposition temperature and a thin substrate is used.

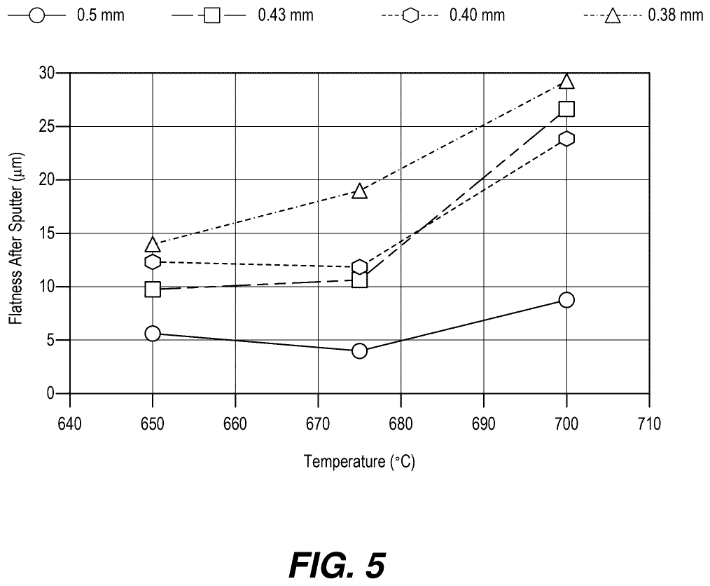

FIG. 5 is an example plot illustrating flatness values after a deposition process for various substrate thicknesses over different deposition temperatures, according to some aspects. The plot of FIG. 5 shows results of experiments using a glass material (e.g., alumino-silicate glass) with the parameters shown in the table below.

| | | |
|---|---|---|
| Specific Gravity | g/cm³ | 2.55 |
| Young's Modulus | GPa | 83 |
| Specific Modulus | | 32.5 |
| Tg/Usable Temperature | ° C. | 780 |
| ° C. Thermal Expansion | ×10⁻⁷ | 28 |
| (R temperature) | | |

In particular, FIG. 5 shows the average flatness values of 25 substrates with four different thicknesses (0.5 mm, 0.43 mm, 0.40 mm, and 0.38 mm) after the HAMR deposition process with the deposition temperatures at 650° C., 675° C. and 700° C. As shown in the plot of FIG. 5, substrates with the substrate thickness of 0.5 mm maintain an acceptable flatness at below 15 micrometers when the deposition temperature increases from 650° C. to 675° C. and to 700° C. However, the substrates with the substrate thicknesses thinner than 0.5 mm show the flatness values substantially increasing (e.g., thus being less flat) for the deposition temperature greater than 675° C. Hence, especially for the thinner substrates (e.g., with the thickness less than 0.5 mm), a higher deposition temperature may have more adverse effects on the flatness of the substrates than a lower deposition temperature.

When a slider head of a data storage device flies over a data surface of a magnetic recording disk, a fly height (spacing, F/H) between the slider and the data surface of the magnetic recording disk is maintained by a combination of a positive pressure under air bearings and a sub-ambient pressure under a cavity area. Due to topographical features on the disk surface such as waviness or runout (e.g., long waviness), the fly height fluctuates as the slider head flies over the data surface. This fluctuation is related to a wavelength and an amplitude associated with the waviness. Air bearing vibrations are also generated by waviness components, but the wavelength is between 20 and 500 μm. These waviness variations are generated by polishing processes during the substrate manufacturing phase. This disclosure deals with waviness whose length is much longer than a slider length (longer than 40 mm). Note that the wavelengths associated with the waviness are not optical (or electromagnetic) wavelengths. They are wavelengths associated with physical variations or fluctuations in the surface of the substrate or layer formed on the substrate.

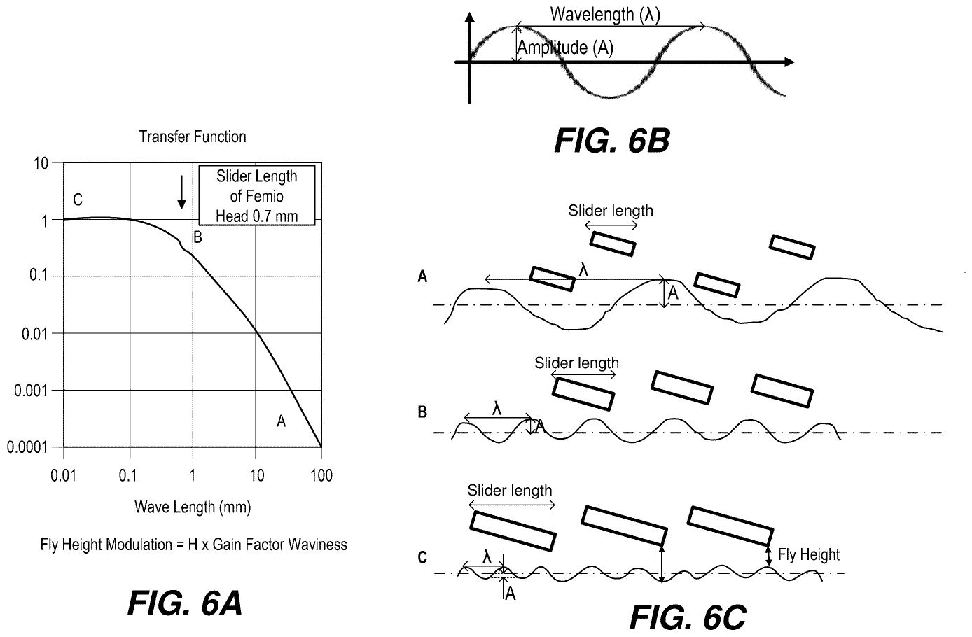

FIG. 6A shows an example plot showing a fly height modulation over wavelength associated with waviness of a surface of a substrate in a tangential direction, according to some aspects. In this plot, a slider head has a length of 0.7 mm. FIG. 6B shows a wavelength and an amplitude of an example periodic curve, according to some aspects. Waviness of the data surface may resemble a periodic curve, and thus a wavelength of the waviness of the data surface may be estimated. FIG. 6C shows an example diagram showing three different waviness curves of a data surface with slider heads in various positions. For Substrate A, a wavelength of a waviness curve is greater than a length of a slider head, and thus the wavelength is long. For this long wavelength, the slider will move up and down to follow the shape of the waviness, and thus the fly height generally stays small and constant during the flyover. For Substrate B, a wavelength of a waviness curve is slightly greater than a length of a slider head, and thus the slider head cannot follow the shape of the waviness very well, thus the fly height fluctuates and may become large. For Substrate C, a wavelength of a waviness curve is much greater than a length of a slider head, and thus the slider head cannot follow the shape of the waviness, thus the fly height fluctuates more than the case with Substrate B and may become larger than the case with Substrate B. Hence, referring back to FIG. 6A, Substrate A shows the smallest fly height modulation, while Substrate C shows the largest fly height modulation.

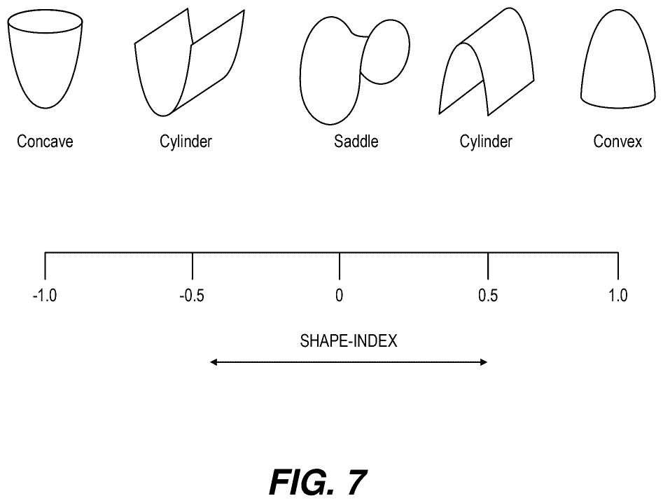

FIG. 7 shows an example diagram showing four types of shapes of a data surface of a magnetic recording disk, according to some aspects. As shown in FIG. 7, a data surface having the concave shape at the shape index −1.0 may have an outer edge (e.g., OD region) of a magnetic recording disk protruding outwardly, while a data surface having the convex shape at the shape index 1.0 may have an ID region of a disk substate protruding outwardly. Further, a data surface having a cylinder shape at the shape index −0.5 have an outer edge of a magnetic recording disk protruding outwardly, while a data surface having a cylinder shape at the shape index 0.5 may have an ID region of a disk substate protruding outwardly. A data surface having a saddle shape at the shape index 0 may have some portions of an outer edge of a magnetic recording disk protruding outwardly while other portions of the outer edge of the magnetic recording disk do not protrude outwardly.

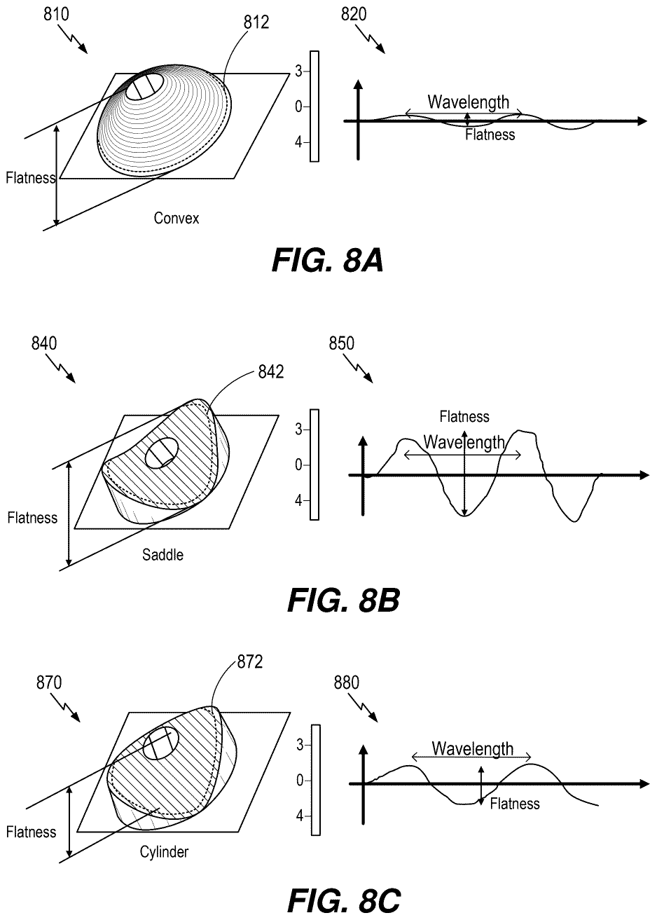

FIGS. 8A-8C show in-depth analysis of various data surface shapes. FIG. 8A shows a result of a surface analysis of a data surface of a magnetic recording disk with a convex shape, according to some aspects. FIG. 8A shows a three dimensional (3D) surface image 810 of a magnetic recording disk with the convex shape. As shown in the 3D surface image 810, an ID region of the magnetic recording disk protrudes outwardly in a convex shape, while an OD region does not. FIG. 8A also shows a height curve 820 generated by height values measured along a circular path 812 around an outer diameter region of the magnetic recording disk with the convex shape. The circular path 812 where the height values are measured may correspond to a track over which a slider head flies for reading data. In the height curve 820, the x-axis represents different locations along the circular path 812 and the y-axis represents the height values. As shown in the height curve 820 of FIG. 8A, the fluctuation of the height values along the circular path 812 is minimal, with the height curve 820 having a very low amplitude (and thus a low flatness value). Hence, it is expected that the fluctuation of the fly height along the circular path 812 is also minimal. Therefore, the magnetic recording disk with the convex shape provides optimal results among the potential shapes.

FIG. 8B shows a result of a surface analysis of a data surface of a magnetic recording disk with a saddle shape, according to some aspects. FIG. 8B shows a 3D surface image 840 of a magnetic recording disk with the saddle shape. As shown in the 3D surface image 840, some portions of the OD region of the magnetic recording disk protrudes outwardly, while other portions of the OD region do not protrude outwardly. Hence, along a circular track around the magnetic recording disk, a lot of fluctuation in height values may be expected. FIG. 8B also shows a height curve 850 generated by height values measured along a circular path 842 around an outer diameter region of the magnetic recording disk with the saddle shape. The circular path 842 where the height values are measured may correspond to a track for reading data. In the height curve 850, the x-axis represents different locations along the circular path 842 and the y-axis represents the height values. As shown in the height curve 850 of FIG. 8B, although the wavelength of the height curve 850 is almost the same as the wavelength of the height curve 820 for the convex shape, the fluctuation of the height values along the circular path 842 is significant with a much higher amplitude for the height curve 850 than for the height curve 820, with the height curve 820 having a very high amplitude (and thus a very high flatness value). Hence, it is expected that the fluctuation of the fly height along the circular path 842 is also expected to be significant. Therefore, the magnetic recording disk with the saddle shape is likely cause a lot of error in reading data along a track, and thus the magnetic recording disk with the saddle shape is not desirable.

FIG. 8C shows a result of a surface analysis of a data surface of a magnetic recording disk with a cylinder shape, according to some aspects. FIG. 8C shows a 3D surface image 870 of a magnetic recording disk with the cylinder shape. As shown in the 3D surface image 870, some portions of the OD region of the magnetic recording disk protrudes outwardly, while other portions of the OD region do not protrude outwardly. However, the surface features of the cylinder shape do not fluctuate as much as the surface features of the saddle shape. FIG. 8C also shows a height curve 880 generated by height values measured along a circular path 882 around an outer diameter region of the magnetic recording disk with the cylinder shape. The circular path 882 where the height values are measured may correspond to a track for reading data. In the height curve 880, the x-axis represents different locations along the circular path 882 and the y-axis represents the height values. As shown in the height curve 880 of FIG. 8C, the fluctuation of the height values along the circular path 872 is mild, with an amplitude for the height curve 880 being smaller than for the height curve 850 of FIG. 8B. Hence, it is expected that the fluctuation of the fly height along the circular path 872 is also expected to be mild. Therefore, the magnetic recording disk with the cylinder shape is not likely to cause much error in reading data along a track.

A smaller amplitude of the height curve generally causes less error in reading data from the data surface. As shown in the above-discussed examples, the experiments show that the convex shape has the least impact on the fly height fluctuation, out of the potential shapes of a data surface of a magnetic recording disk. Further, concave shapes are mere an inverse shape of a convex shape, and thus also has the least impact on the fly height fluctuation. The saddle shape causes the most fly height fluctuation and is expected to cause the most amount of error in reading data. The cylinder shape has more impact on the fly height fluctuation than the convex shape or the concave shape, but less impact on the fly height fluctuation than the saddle shape. These findings indicate that an acceptable flatness of a magnetic recording disk for a data storage device may vary depending on a shape of a data surface of the magnetic recording disk. For example, the flatness limit can be higher than a conventional flatness limit if the shape of the data surface is a concave shape or a convex shape or a cylindrical shape, while the flatness limit will be lower for a saddle shape.

According to some aspects of the disclosure, a flatness threshold for a magnetic recording disk suitable for a data storage device is determined (e.g., by an apparatus) based on a shape of a data surface of the magnetic recording disk, such that the apparatus can determine whether to utilize (select) the magnetic recording disk for the data storage device by comparing the flatness value of the magnetic recording disk and the flatness threshold that is based on the shape of the data surface. Hence, based on the shape of the data surface, the flatness threshold may vary. As discussed above, the shape of the data surface is a concave shape or a convex shape or a cylinder shape or a saddle shape. The flatness value of the magnetic recording disk is calculated based on a height difference between a highest point and a lowest point on the data surface of the magnetic recording disk. If the flatness value of the magnetic recording disk is less than the flatness threshold, the apparatus may determine to utilize the magnetic recording disk for the magnetic medium. On the other hand, if the flatness value of the magnetic recording disk exceeds the flatness threshold, the apparatus may determine not to utilize the magnetic recording disk for the data storage device (that is, the disk is rejected). As discussed above, the magnetic recording disk may be formed after a glass substrate (e.g., made of alumino-silicate glass) undergoes the fabrication process, and thus the magnetic recording disk may include a glass substrate.

In some aspects, the flatness value may be affected by an external force, such as a clamping force by a spindle assembly (e.g., spindle assembly 104) to clamp the magnetic recording disk onto a spindle hub of the spindle assembly. For example, if the clamping force causes an additional flatness degradation on the magnetic recording disk, the flatness threshold may be reduced by an external flatness factor caused by the clamping force.

As discussed above, during the deposition process using a particular deposition temperature, one or more layers may be deposited on the glass substrate to form the magnetic recording disk. Monitoring the flatness value may be useful especially when a higher deposition temperature (e.g., higher than a particular reference temperature) is used for the deposition process because the higher deposition temperature causes more flatness degradations. In some aspects, a deposition temperature used to deposit one or more layers on the glass substrate to form the magnetic recording disk may be greater than a reference temperature, where the reference temperature is 75 degrees Celsius less than a glass transition temperature (Tg) of the glass substrate. In an example where the Tg of the substrate is 750 degrees Celsius, the reference temperature may be 675 degrees Celsius. Hence, in some aspects, the magnetic recording disk may include one or more layers deposited on the glass substrate using the deposition temperature greater than 675 degrees Celsius. As discussed above, the flatness changes more drastically when a deposition temperature for depositing layers(s) on the substrate is greater than the reference temperature. Hence, in some aspects, the flatness threshold may be determined for the magnetic recording disk to which the deposition temperature greater than the reference temperature (e.g., 675 degrees Celsius) is applied during a deposition process.

In an aspect, the flatness threshold is the highest for the concave shape and the convex shape, and then the flatness threshold is lower for the cylinder shape and the lowest for the saddle shape. In an aspect, one flatness threshold may be used for the concave shape, the convex shape, and the cylinder shape and a different flatness threshold may be used for the saddle shape. This is at least because the concave shape, the convex shape, and the cylinder shape have less fly height fluctuation than the saddle shape and thus a higher flatness value can be tolerated for these shapes, as discussed above. On the other hand, the fly height fluctuation for the saddle shape is expected to be high, as discussed above, and thus the saddle shape can tolerate a lower flatness value. In an example, if the same flatness threshold is used for the concave shape, the convex shape, and the cylinder shape, the flatness threshold for the cylinder shape may be used for the flatness threshold for the concave shape, the convex shape, and the cylinder shape, because the flatness threshold for the cylinder shape is lower than the flatness threshold for the concave shape and the convex shape. Because the convex shape and the concave shape have the least impact on the fly height fluctuation, the flatness threshold for the concave shape, the convex shape, and the cylinder shape may be determined by the flatness threshold for the cylinder shape.

In some aspects, the thickness of the magnetic recording disk may be less than 0.5 millimeters (mm). In an aspect, the thickness of the magnetic recording disk may be substantially equal to the thickness of the glass substrate (i.e., the magnetic recording layers and other layers deposited on the substrate are very thin compared to the substrate itself). According to experiment results, for example, when the thickness of the substrate is less than 0.5 mm and the flatness value for the substrate is higher than 15 micrometers, then the substrate is acceptable up to the flatness value of 40 micrometers if the shape of the data surface is the concave shape or the convex shape or the cylinder shape, and is not acceptable if the shape of the data surface is the saddle shape. Hence, in this aspect where the thickness of the magnetic recording disk is less than 0.5 millimeters, if the apparatus determines that the shape of the data surface is one of the concave shape, the convex shape, or the cylinder shape, the apparatus determines that the flatness threshold is 40 micrometers. Further, in this aspect where the thickness of the magnetic recording disk is less than 0.5 millimeters, if the apparatus determines that the shape of the data surface is the saddle shape, the apparatus determines that the flatness threshold is 15 micrometers. In some aspects, this feature may be applied especially if the deposition temperature greater than the reference temperature (e.g., 675 degrees Celsius) is used to deposit layer(s) on the glass substrate to form the magnetic recording disk.

In some aspects, the flatness threshold for any of the concave shape, the convex shape, or the cylinder shape may be four times greater than the flatness threshold for the saddle shape. In this aspect, the flatness threshold may be set to 40 micrometers if the apparatus determines that the shape of the data surface is the concave shape, the convex shape, or the cylinder shape. Further, in this aspect, the flatness threshold may be set to 15 micrometers if the apparatus determines that the shape of the data surface is the saddle shape.

In some aspects, the flatness threshold is further based on at least one of a ramp-disk spacing for a preselected hard disk drive and a fly height based on spacing between a slider head and the data surface with the preselected hard disk drive. For example, in the hard drive having multiple storage disks, each storage disk may be loaded into or unloaded from a corresponding ramp. The ramp-disk spacing is a space between a data surface of the storage disk and the corresponding ramp. For a greater ramp-disk spacing, a higher flatness threshold may be used. Further, if the fly height can be increased, then a higher flatness threshold may be used.

In some aspects, the shape of the data surface may be estimated or otherwise determined using at least one of currently available surface analysis methods. In one aspect, the shape of the data surface may be estimated based on light interference measurements on the data surface. For example, a light interferometer or another light-based surface analysis device may be used to estimate the shape of the data surface.

In some aspects, the shape of the data surface may be estimated or otherwise determined based on OD height values (or first height values) that are measured around an OD region of the magnetic recording disk. As discussed above with reference to FIGS. 8A, 8B, and 8C, a height curve generated with OD height values measured along an OD circular path or track in an OD region of the magnetic recording disk provides a distinct amplitude that can be used to estimate the shape of the data surface. For example, as shown in FIG. 8A, if the height curve based on the OD height values measured along an OD circular path in the OD region indicates a very low amplitude (e.g., below a low amplitude threshold), the shape of the data surface may be estimated as the convex shape or the concave shape. For example, as shown in FIG. 8B, if the height curve based on the OD height values measured along an OD circular path in the OD region indicates a high amplitude (e.g., above a high amplitude threshold), the shape of the data surface may be estimated as the saddle shape. For example, as shown in FIG. 8C, if the height curve based on the OD height values measured along an OD circular path in the OD region indicates a medium amplitude (e.g., between the low amplitude threshold and the high amplitude threshold), then the shape of the data surface may be estimated as the cylinder shape.

In some aspects, a wavelength of a periodic curve that corresponds to a curve generated based on the OD height values over various locations on the OD circular path respectively corresponding to the OD height values may be greater than a length of a slider head. For example, as described above with reference to in FIG. 6A, if the length of the slider head is shorter than the wavelength of the waviness of the data surface, which also corresponds to the wavelength of the height curve generated based on the OD height values, the fly height will fluctuate less.

In some aspects, in addition to the OD height values, the apparatus may also measure ID height values (or second height values) along an ID circular path around an ID region of the data surface near a center of the magnetic recording disk. Then, the flatness value may be calculated based on a highest value and a lowest value among the OD height values and the ID height values.

In some aspects, the height values such as the OD height values and the ID height values may be measured using a capacitive sensor and/or a laser sensor. For example, a capacitive sensor and/or a laser sensor capable of measuring a distance may be used to measure the height values.

According to some aspects of the disclosure, for a magnetic recording disk (e.g., for a data storage device) with a thickness less than 0.5 millimeter and including a glass substrate having a data surface that includes one of a concave shape, a convex shape, and a cylinder shape, the flatness value of the magnetic recording disk is greater than a first flatness threshold. Here, the flatness value corresponds to a height difference between a highest point and a lowest point on the data surface. Hence, the magnetic recording disk having the thickness less than 0.5 millimeter includes the glass substrate having the data surface and a magnetic recording layer on the data surface for magnetic recording, where the magnetic recording disk has a flatness value corresponding to a height difference between a highest point and a lowest point on the data surface, and the flatness value is greater than a first flatness threshold and the data surface comprises one of a concave shape, a convex shape, and a cylinder shape. In this aspect, the first flatness threshold may be 15 micrometers.

In an aspect, for the magnetic recording disk with the thickness less than 0.5 millimeter and having the data surface that includes the concave shape, the flatness value of the magnetic recording disk is greater than the first flatness threshold. Further, in an aspect, for the magnetic recording disk with the thickness less than 0.5 millimeter and having the data surface that includes the convex shape, the flatness value of the magnetic recording disk is greater than the first flatness threshold. Further, in an aspect, for the magnetic recording disk with the thickness less than 0.5 millimeter and having the data surface that includes the cylinder shape, the flatness value of the magnetic recording disk is greater than the first flatness threshold. However, if a magnetic recording disk with the thickness less than 0.5 millimeter has the data surface including a saddle shape and the flatness value is greater than the first flatness threshold, this magnetic recording disk may not be suitable for a data storage device. For this type of magnetic recording disk with the saddle shape data surface to be suitable for a data storage device, the flatness value needs to be less than or equal to the first flatness threshold. In an aspect, the shape of the data surface may be estimated based on light interference measurements on the data surface.

In an aspect, the flatness value may be greater than the first flatness threshold and less than or equal to a second flatness threshold. In an aspect, the first flatness threshold may be 15 micrometers, and the second flatness threshold may be 40 micrometers. In another aspect, the second flatness threshold may be four times greater than the first flatness threshold.

In an aspect, a shape of the data surface may be estimated based on first height values (or OD height values) along a first circular path around an outer diameter region of the data surface near an outer diameter edge. In an aspect, the flatness value may be based on a highest value and a lowest value among the first height values and second height values (or ID height values) along a second circular path around an inner diameter region of the data surface near a center of the magnetic recording disk. In an aspect, a wavelength of a periodic curve that corresponds to a curve generated based on the first height values over multiple locations on the first circular path, respectively corresponding to the first height values, may be greater than a length of a slider head.

In an aspect, the first flatness threshold may be based on at least one of a ramp-disk spacing for a preselected hard disk drive and a fly height based on spacing between a slider head and the data surface with the preselected hard disk drive.

In an aspect, the magnetic recording layer may be deposited on the data surface with a deposition temperature that is greater than a reference temperature, the reference temperature being 75 degrees Celsius less than a glass transition temperature of the glass substrate. In this aspect, the reference temperature is 675 degrees Celsius.

In another aspect, for a magnetic recording disk (e.g., for a data storage device) with a thickness less than 0.5 millimeter and including a glass substrate having a data surface that includes one of the concave shape, the convex shape, the cylinder shape, and a saddle shape, the flatness value of the magnetic recording disk is less than or equal a first flatness threshold.

According to some aspects of the disclosure, a data storage device includes the magnetic recording disk discussed above, at least one magnetic head, a drive mechanism for positioning the at least one magnetic head over the magnetic recording disk, and a controller electrically coupled to the at least one magnetic head for controlling operation of the at least one magnetic head. As discussed above, the magnetic recording disk includes the glass substrate having the data surface and the magnetic recording layer on the data surface for magnetic recording and has the thickness less than 0.5 millimeter, where the magnetic recording disk has a flatness value corresponding to a height difference between a highest point and a lowest point on the data surface, and the flatness value is greater than a first flatness threshold and the data surface comprises one of a concave shape, a convex shape, and a cylinder shape.

In an aspect, the data storage device may further include a second magnetic recording disk having a second glass substrate having a second data surface, a second magnetic recording layer on the second data surface for magnetic recording, and a thickness less than 0.5 millimeter, where the second magnetic recording disk has a second flatness value corresponding to a height difference between a highest point and a lowest point on the second data surface, and where the second flatness value is less than or equal to the first flatness threshold and the second data surface comprises one of the concave shape, the convex shape, the cylinder shape, and a saddle shape.

In an aspect, the data storage device may further include a slider that includes the at least one magnetic head; a laser configured to generate light; and a near field transducer (NFT) configured to receive the light and generate a localized heat, where the magnetic recording disk includes a heat sink layer configured to dissipate the localized heat during a writing process.

According to some aspects of the disclosure, a data storage device configured for magnetic recording includes magnetic recording disks and at least one magnetic head configured to read from, and write to, the magnetic recording disks. Each of magnetic recording disks has the following properties. In particular, each magnetic recording disk has a magnetic recording layer for magnetic recording, where each magnetic recording disk has a thickness of less than 0.5 millimeter, and each of the magnetic recording disks includes a glass substrate and a data surface, where each magnetic recording disk has a flatness value corresponding to a height difference between a highest point and a lowest point on the data surface. Further, at least one of the magnetic recording disks has a flatness value greater than 15 micrometers with a data surface including one of a concave shape, a convex shape, and a cylinder shape, and at least one of the magnetic recording disks has a flatness value less than or equal to 15 micrometers with a data surface including one of the concave shape, the convex shape, the cylinder shape, and a saddle shape. In an example, any one of the magnetic recording disks with a flatness value greater than 15 micrometers includes an estimated shape of a data surface being one of a concave shape, a convex shape, and a cylinder shape, while any one of the magnetic recording disks with the flatness value less than or equal to 15 micrometers includes an estimated shape of a data surface being one of the concave shape, the convex shape, the cylinder shape, and a saddle shape. In an aspect, the magnetic recording layer on each of the magnetic recording disks may be deposited with a deposition temperature greater than a reference temperature (e.g., 675 degrees Celsius), the reference temperature being 75 degrees Celsius less than a glass transition temperature of the glass substrate.

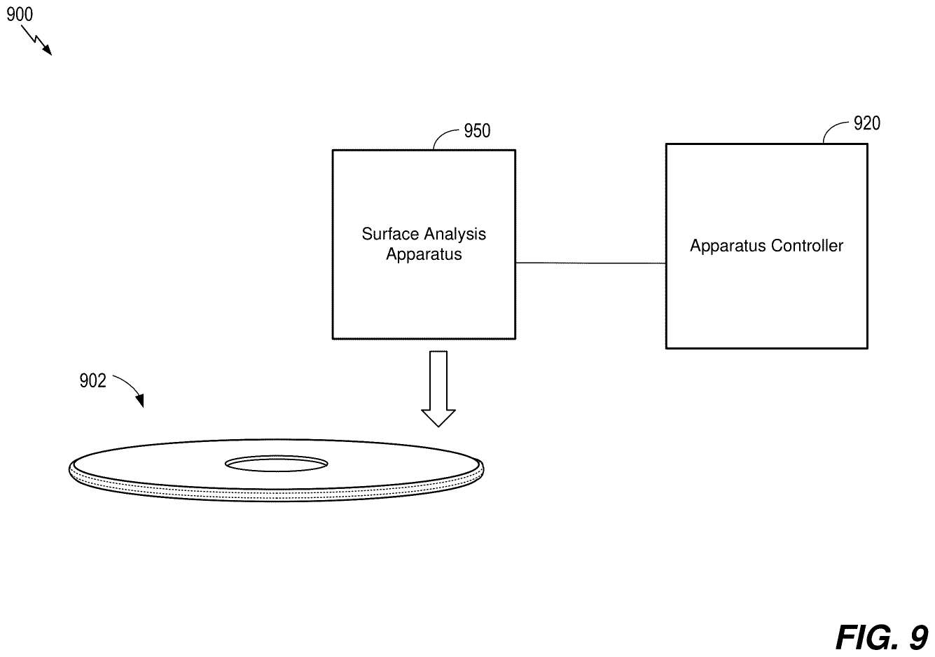

FIG. 9 illustrates an exemplary diagram for an apparatus 900 for identifying a magnetic recording disk suitable for a data storage device configured for magnetic recording, according to some aspects. In FIG. 9, the apparatus 900 may include an apparatus controller 920 and a surface analysis apparatus 950. In particular, the surface analysis apparatus 950 is configured to estimate a shape of a data surface of the magnetic recording disk 902, where the shape of the data surface may be estimated to be one of a concave shape, a convex shape, a cylinder shape, and a saddle shape. In some aspects, the surface analysis apparatus 950 may measure first height values along a first circular path around an outer diameter region of the data surface near an outer diameter edge, and estimate the shape of the data surface based on the first height values. In some aspects, the surface analysis apparatus 950 may estimate the shape of the data surface based on light interference measurements on the data surface. The apparatus controller 920 is configured to determine a flatness threshold for the magnetic recording disk based on the shape of the data surface and to calculate a flatness value of the magnetic recording disk based on a height difference between a highest point and a lowest point on the data surface of the magnetic recording disk. In some aspects, the surface analysis apparatus 950 may measure second height values along a second circular path around an inner diameter region of the data surface near a center of the magnetic recording disk, such that the apparatus controller 920 may calculate the flatness value based on a highest value and a lowest value among the first height values and the second height values. The apparatus controller 920 is further configured to compare the flatness value and the flatness threshold and to determine to utilize the magnetic recording disk for the magnetic medium based on the comparison of the flatness value and the flatness threshold.

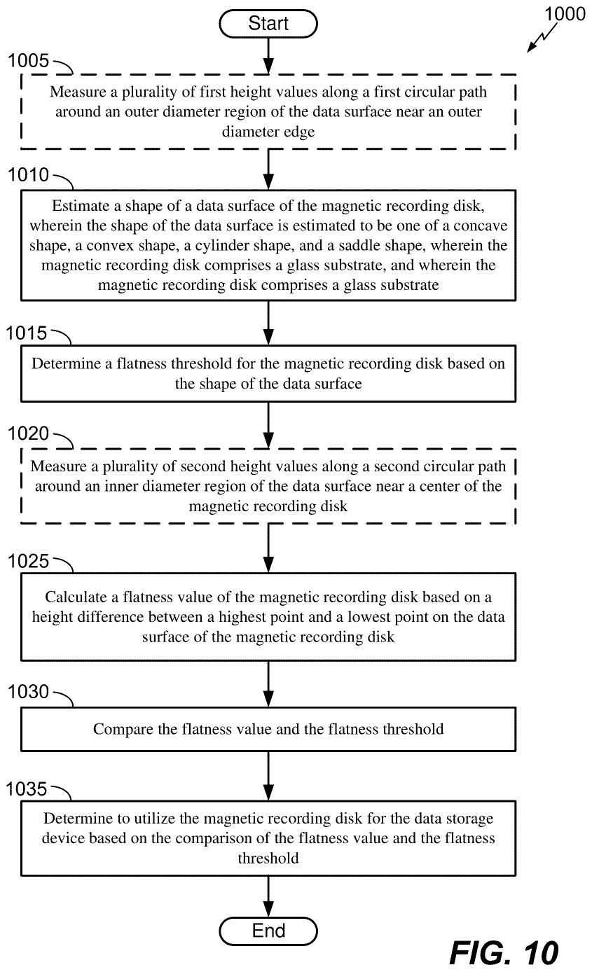

FIG. 10 illustrates a method 1000 for identifying a magnetic recording disk suitable for a data storage device configured for magnetic recording, according to some aspects. In some aspects, the magnetic recording disk may include a glass substrate. In some aspects, the method 1000 may be performed by an apparatus for identifying a glass substrate suitable for a magnetic medium of a data storage device configured for magnetic recording, such as the apparatus 900 of FIG. 9.

In some aspects, at block 1005, the apparatus may measure a plurality of first height values along a first circular path around an outer diameter region of the data surface near an outer diameter edge.

In some aspects, the plurality of first height values may be measured using at least one of a capacitive sensor or a laser sensor.

In some aspects, a wavelength of a periodic curve that corresponds to a curve generated based on the plurality of first height values over a plurality of locations on the first circular path, respectively corresponding to the plurality of first height values, may be greater than a length of a slider head.

At block 1010, the apparatus estimates a shape of a data surface of the magnetic recording disk, wherein the shape of the data surface is estimated to be one of a concave shape, a convex shape, a cylinder shape, and a saddle shape.

In some aspects, the shape of the data surface may be estimated based on the first height values.

In some aspects, the shape of the data surface may be estimated based on light interference measurements on the data surface.

At block 1015, the apparatus determines a flatness threshold for the magnetic recording disk based on the shape of the data surface.

In some aspects, a thickness of the magnetic recording disk may be less than 0.5 millimeters (mm). In this aspect, the flatness threshold may be set to 40 micrometers in response to a determination that the shape of the data surface is one of the concave shape, the convex shape, or the cylinder shape, and the flatness threshold may be set to 15 micrometers in response to a determination that the shape of the data surface is the saddle shape.

In some aspects, the flatness threshold for any of the concave shape, the convex shape, or the cylinder shape may be four times greater than the flatness threshold for the saddle shape. In this aspect, the flatness threshold may be set to 40 micrometers in response to a determination that the shape of the data surface is the concave shape, the convex shape, or the cylinder shape, and the flatness threshold may be set to 15 micrometers in response to a determination that the shape of the data surface is the saddle shape.

In some aspects, the flatness threshold may be further based on at least one of a ramp-disk spacing for a preselected hard disk drive and a fly height based on spacing between a slider head and the data surface with the preselected hard disk drive.

In some aspects, at block 1020, the apparatus may measure a plurality of second height values along a second circular path around an inner diameter region of the data surface near a center of the magnetic recording disk. In this aspect, the flatness value may be calculated based on a highest value and a lowest value among the plurality of first height values and the plurality of second height values

At block 1025, the apparatus calculates a flatness value of the magnetic recording disk based on a height difference between a highest point and a lowest point on the data surface of the magnetic recording disk.

At block 1030, the apparatus compares the flatness value and the flatness threshold.

At block 1035, the apparatus determines to utilize the magnetic recording disk for the data storage device based on the comparison of the flatness value and the flatness threshold.

In some aspects, the determining to utilize the magnetic recording disk at block 1035 may include: determining that the magnetic recording disk is acceptable for use within the magnetic medium in response to determining that the flatness value is less than or equal to the flatness threshold, and determining that the magnetic recording disk is unacceptable for use within the magnetic medium in response to determining that the flatness value is greater than the flatness threshold.

In some aspects, the magnetic recording disk comprises one or more layers deposited on the glass substrate using a deposition temperature greater than a reference temperature, the reference temperature being 75 degrees Celsius less than a glass transition temperature of the glass substrate. In some aspects, the reference temperature may be 675 degrees Celsius.

In some aspects, a separate apparatus, processor, device, or circuit may be provided for performing or controlling the operations shown in FIG. 10. For example, the following may be provided: means for measuring a plurality of first height values along a first circular path around an outer diameter region of a data surface near an outer diameter edge; means for estimating a shape of a data surface of the magnetic recording disk, wherein the shape of the data surface is estimated to be one of a concave shape, a convex shape, a cylinder shape, and a saddle shape; means for determining a flatness threshold for the magnetic recording disk based on the shape of the data surface; means for measuring a plurality of second height values along a second circular path around an inner diameter region of the data surface near a center of the magnetic recording disk; means for calculating a flatness value of the magnetic recording disk based on a height difference between a highest point and a lowest point on the data surface of the magnetic recording disk; means for comparing the flatness value and the flatness threshold; and means for determining to utilize the magnetic recording disk for the data storage device based on the comparison of the flatness value and the flatness threshold. The means for determining to utilize the magnetic recording disk may include: means for determining that the magnetic recording disk is acceptable for use with the data storage device in response to determining that the flatness value is less than or equal to the flatness threshold; and means for determining that the magnetic recording disk is unacceptable for use with the data storage device in response to determining that the flatness value is greater than the flatness threshold.

### Additional Aspects

The examples set forth herein are provided to illustrate certain concepts of the disclosure. The apparatuses, devices, or components illustrated above may be configured to perform one or more of the methods, features, or steps described herein. Those of ordinary skill in the art will comprehend that these are merely illustrative in nature, and other examples may fall within the scope of the disclosure and the appended claims. Based on the teachings herein those skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein.

Aspects of the present disclosure have been described above with reference to schematic flowchart diagrams and/or schematic block diagrams of methods, apparatuses, systems, and computer program products according to aspects of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

The subject matter described herein may be implemented in hardware, software, firmware, or any combination thereof. As such, the terms “function,” “module,” and the like as used herein may refer to hardware, which may also include software and/or firmware components, for implementing the feature being described. In one example implementation, the subject matter described herein may be implemented using a computer readable medium having stored thereon computer executable instructions that when executed by a computer (e.g., a processor) control the computer to perform the functionality described herein. Examples of computer-readable media suitable for implementing the subject matter described herein include non-transitory computer-readable media, such as disk memory devices, chip memory devices, programmable logic devices, and application specific integrated circuits. In addition, a computer readable medium that implements the subject matter described herein may be located on a single device or computing platform or may be distributed across multiple devices or computing platforms.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding aspects. For instance, an arrow may indicate a waiting or monitoring period of unspecified duration between enumerated steps of the depicted aspect.

The various features and processes described above may be used independently of one another, or may be combined in various ways. All possible combinations and sub-combinations are intended to fall within the scope of this disclosure. In addition, certain method, event, state or process blocks may be omitted in some implementations. The methods and processes described herein are also not limited to any particular sequence, and the blocks or states relating thereto can be performed in other sequences that are appropriate. For example, described tasks or events may be performed in an order other than that specifically disclosed, or multiple may be combined in a single block or state. The example tasks or events may be performed in serial, in parallel, or in some other suitable manner. Tasks or events may be added to or removed from the disclosed example aspects. The example systems and components described herein may be configured differently than described. For example, elements may be added to, removed from, or rearranged compared to the disclosed example aspects.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The word “exemplary” is used herein to mean “serving as an example, instance, or illustration.” Any aspect described herein as “exemplary” is not necessarily to be construed as preferred or advantageous over other aspects. Likewise, the term “aspects” does not require that all aspects include the discussed feature, advantage or mode of operation.

While the above descriptions contain many specific aspects of the invention, these should not be construed as limitations on the scope of the invention, but rather as examples of specific aspects thereof. Accordingly, the scope of the invention should be determined not by the aspects illustrated, but by the appended claims and their equivalents. Moreover, reference throughout this specification to “one aspect,” “an aspect,” or similar language means that a particular feature, structure, or characteristic described in connection with the aspect is included in at least one aspect of the present disclosure. Thus, appearances of the phrases “in one aspect,” “in an aspect,” and similar language throughout this specification may, but do not necessarily, all refer to the same aspect, but mean “one or more but not all aspects” unless expressly specified otherwise.

The terminology used herein is for the purpose of describing particular embodiments only and is not intended to be limiting of the embodiments. As used herein, the singular forms “a,” “an” and “the” are intended to include the plural forms as well (i.e., one or more), unless the context clearly indicates otherwise. An enumerated listing of items does not imply that any or all of the items are mutually exclusive and/or mutually inclusive, unless expressly specified otherwise. It will be further understood that the terms “comprises,” “comprising,” “includes” “including,” “having,” and variations thereof when used herein mean “including but not limited to” unless expressly specified otherwise. That is, these terms may specify the presence of stated features, integers, steps, operations, elements, or components, but do not preclude the presence or addition of one or more other features, integers, steps, operations, elements, components, or groups thereof. Moreover, it is understood that the word “or” has the same meaning as the Boolean operator “OR,” that is, it encompasses the possibilities of “either” and “both” and is not limited to “exclusive or” (“XOR”), unless expressly stated otherwise. It is also understood that the symbol “/” between two adjacent words has the same meaning as “or” unless expressly stated otherwise. Moreover, phrases such as “connected to,” “coupled to” or “in communication with” are not limited to direct connections unless expressly stated otherwise.

Any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be used there or that the first element must precede the second element in some manner. Also, unless stated otherwise a set of elements may include one or more elements. In addition, terminology of the form “at least one of a, b, or c” or “a, b, c, or any combination thereof” used in the description or the claims means “a or b or c or any combination of these elements.” For example, this terminology may include a, or b, or c, or a and b, or a and c, or a and b and c, or 2a, or 2b, or 2c, or 2a and b, and so on. The term “about ‘value X’”, or “approximately value X,” as used in the disclosure shall mean within 10 percent of the ‘value X’. For example, a value of about 1 or approximately 1, would mean a value in a range of 0.9-1.1. In one aspect, “about” as used herein may instead mean 5 percent. In this disclosure, various numerical values are presented. Unless specifically indicated otherwise, it is contemplated that these numerical values may have a tolerance of 10 percent. In another aspect, the tolerance may be 5 percent. In the disclosure various ranges in values may be specified, described and/or claimed. It is noted that any time a range is specified, described and/or claimed in the specification and/or claim, it is meant to include the endpoints (at least in one embodiment). In another embodiment, the range may not include the endpoints of the range. Various components described in this specification may be described as “including” or made of certain materials or compositions of materials. In one aspect, this can mean that the component consists of the particular material(s). In another aspect, this can mean that the component comprises the particular material(s).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

What is claimed is:

1. A magnetic recording disk, comprising:
a glass substrate having a data surface; and
a magnetic recording layer on the data surface for magnetic recording,
wherein the magnetic recording disk has a thickness less than 0.5 millimeter,
wherein the magnetic recording disk has a flatness value corresponding to a height difference between a highest point and a lowest point on the data surface, and
wherein the flatness value is greater than a first flatness threshold and the data surface comprises one of a concave shape, a convex shape, and a cylinder shape.

2. The magnetic recording disk of claim 1, wherein the first flatness threshold is 15 micrometers.

3. The magnetic recording disk of claim 1, wherein the flatness value is greater than the first flatness threshold and less than or equal to a second flatness threshold when the data surface comprises one of the concave shape, the convex shape, and the cylinder shape.

4. The magnetic recording disk of claim 3, wherein the first flatness threshold is 15 micrometers, and the second flatness threshold is 40 micrometers.

5. The magnetic recording disk of claim 3, wherein the second flatness threshold is four times greater than the first flatness threshold.

6. The magnetic recording disk of claim 1, wherein a shape of the data surface is estimated based on a plurality of first height values along a first circular path around an outer diameter region of the data surface near an outer diameter edge.

7. The magnetic recording disk of claim 6, wherein the flatness value is based on a highest value and a lowest value among the plurality of first height values and a plurality of second height values along a second circular path around an inner diameter region of the data surface near a center of the magnetic recording disk.

8. The magnetic recording disk of claim 6, wherein a wavelength of a periodic curve that corresponds to a curve generated based on the plurality of first height values over a plurality of locations on the first circular path, respectively corresponding to the plurality of first height values, is greater than a length of a slider head.

9. The magnetic recording disk of claim 1, wherein the shape of the data surface is estimated based on light interference measurements on the data surface.

10. The magnetic recording disk of claim 1, wherein the first flatness threshold is based on at least one of a ramp-disk spacing for a preselected hard disk drive and a fly height based on spacing between a slider head and the data surface with the preselected hard disk drive.

11. The magnetic recording disk of claim 1, wherein the magnetic recording layer is deposited on the data surface with a deposition temperature that is greater than a reference temperature, the reference temperature being 75 degrees Celsius less than a glass transition temperature of the glass substrate.

12. The magnetic recording disk of claim 11, wherein the reference temperature is 675 degrees Celsius.

13. The magnetic recording disk of claim 1, wherein the data surface comprises the concave shape.

14. The magnetic recording disk of claim 1, wherein the data surface comprises the convex shape.

15. The magnetic recording disk of claim 1, wherein the data surface comprises the cylinder shape.

16. A data storage device, comprising:
the magnetic recording disk of claim 1;
at least one magnetic head;
a drive mechanism for positioning the at least one magnetic head over the magnetic recording disk; and
a controller electrically coupled to the at least one magnetic head for controlling operation of the at least one magnetic head.

17. The data storage device of claim 16, further comprising:
a second magnetic recording disk comprising:
a second glass substrate having a second data surface; and
a second magnetic recording layer on the second data surface for magnetic recording,
wherein the second magnetic recording disk has a thickness less than 0.5 millimeter,
wherein the second magnetic recording disk has a second flatness value corresponding to a height difference between a highest point and a lowest point on the second data surface, and
wherein the second flatness value is less than or equal to the first flatness threshold and the second data surface comprises one of the concave shape, the convex shape, the cylinder shape, and a saddle shape.

18. The data storage device of claim 16, further comprising a slider comprising:
the at least one magnetic head; a laser configured to generate light; and
a near field transducer (NFT) configured to receive the light and generate a localized heat,
wherein the magnetic recording disk comprises a heat sink layer configured to dissipate the localized heat during a writing process.

19. A method of identifying a magnetic recording disk suitable for a data storage device configured for magnetic recording, the method comprising:
estimating a shape of a data surface of the magnetic recording disk, wherein the shape of the data surface is estimated to be one of a concave shape, a convex shape, a cylinder shape, and a saddle shape, and wherein the magnetic recording disk comprises a glass substrate;
determining a flatness threshold for the magnetic recording disk based on the shape of the data surface;
calculating a flatness value of the magnetic recording disk based on a height difference between a highest point and a lowest point on the data surface of the magnetic recording disk;
comparing the flatness value and the flatness threshold; and
determining to utilize the magnetic recording disk for the data storage device based on the comparison of the flatness value and the flatness threshold.

20. The method of claim 19, wherein a thickness of the magnetic recording disk is less than 0.5 millimeters (mm),
wherein the flatness threshold is set to 40 micrometers in response to a determination that the shape of the data surface is one of the concave shape, the convex shape, or the cylinder shape, and
wherein the flatness threshold is set to 15 micrometers in response to a determination that the shape of the data surface is the saddle shape.

21. The method of claim 19, wherein the determining to utilize the magnetic recording disk comprises:
determining that the magnetic recording disk is acceptable for use with the data storage device in response to determining that the flatness value is less than or equal to the flatness threshold; and
determining that the magnetic recording disk is unacceptable for use with the data storage device in response to determining that the flatness value is greater than the flatness threshold.

22. The method of claim 19, further comprising:
measuring a plurality of first height values along a first circular path around an outer diameter region of the data surface near an outer diameter edge,
wherein the shape of the data surface is estimated based on the plurality of first height values.

23. The method of claim 22, wherein a wavelength of a periodic curve that corresponds to a curve generated based on the plurality of first height values over a plurality of locations on the first circular path, respectively corresponding to the plurality of first height values, is greater than a length of a slider head.

24. The method of claim 19:
wherein the flatness threshold for any of the concave shape, the convex shape, or the cylinder shape is four times greater than the flatness threshold for the saddle shape.

25. The method of claim 19, wherein the magnetic recording disk comprises one or more layers deposited on the glass substrate using a deposition temperature greater than a reference temperature, the reference temperature being 75 degrees Celsius less than a glass transition temperature of the glass substrate.
